(19) United States
(12) Patent Application Publication
(10) Pub. No.: US 2021/0078847 A1
(43) Pub. Date: Mar. 18, 2021

(54) Devices, Systems and Processes for Providing Information Regarding and Controlling Dispensing of a Consumable

(71) Applicant: DISH Network L.L.C., Englewood, CO (US)

(72) Inventor: Neil Marten, Lakewood, CO (US)

(73) Assignee: DISH Network L.L.C., Englewood, CO (US)

(21) Appl. No.: 16/574,389

(22) Filed: Sep. 18, 2019

(51) Int. Cl. B67D 1/08; H04B 5/00; H04W 4/38; H04W 4/80

(52) U.S. Cl. CPC B67D 1/0884; B67D 1/0801; B67D 2001/0811; H04W 4/38; H04W 4/80; H04B 5/0031

(57) ABSTRACT

A system, device and method of use includes a data processing system configured to enable a first entity to control dispensing of a consumable provided in a package. An Internet-of-Things (IoT) device is directly associated with the package. A communications system communicatively couples the IoT device with the data processing system. The package may be a beer keg. The IoT device may include a valve for controlling the package by selecting an operating state for the valve. The data processing system enables a user to remotely control the valve. The IoT device captures and communicates consumable data, such as environmental data, location data, consumption data, and transactional data, to the data processing system. Transactional data may include payment information provided by a consumer. The IoT device controls the operating state of the valve based upon the payment information provided by the consumer.

### TECHNICAL FIELD

The technology described herein generally relates to devices, systems, and processes for providing producers of beverages, foods and other consumable products with information regarding a consumable product (herein, each a “consumable”) and controlling dispensing of the consumable. More specifically, the various embodiments disclosed generally relate to capturing and providing producers and others with data regarding a consumable, such as a location, status, environmental conditions, and other information (herein, “consumable data”). The various embodiments disclosed also generally relate to providing producers and others with a device configured to control dispensing of a consumable. The information provided may be real-time, as defined herein. The various embodiments disclosed generally relate to utilizing one or more Internet-of-Things (IoT) devices for interconnection with a consumable, or packaging thereof, in order to provide a monitoring entity with consumable data regarding and control of dispensing of a consumable.

### BACKGROUND

Today, producers of consumables, such as beverages, foods, and other items that may degrade in quality and/or effectiveness over time, or when not stored, transported or otherwise managed in accordance with one or more desired environmental conditions, are often not provided with relevant, real-time information regarding such consumable. While contractual conditions, business arrangements, standard business practices, best interests of producers, retailers and/or consumers may influence how a consumable is handled or otherwise provided throughout a production—distribution—sell—consumption chain of commerce for a given consumable (individually, stages of a collective “consumable chain”), interested parties often do not know specifics regarding the same. For example, the producer may not know whether a consumable, such as beer, has been improperly handled throughout a consumable chain such that the ultimate end user, a consumer thereof, is not presented with “old” (i.e., beer sold past a sell by date), “flat” (i.e., beer that has a less than a desired level of carbonization), “warm” beer (i.e., beer that is above a desired temperature range), or an otherwise non-optimal, degraded, defective, non-recommended and/or otherwise undesired product. It is to be appreciated, that the providing of a consumable under other than desired and/or recommended conditions may effect a given consumer's appreciation (or lack thereof) for the consumable—with potential related impacts on ultimate acceptance and repeat consumption of the consumable by a given population of potential consumers and/or actual consumers.

Likewise, information regarding an inventory, location and/or status of a given consumable is often unavailable. Accordingly, a need exists to provide a producer and others with consumable data regarding a given consumable throughout one or more stages of the consumable chain.

### SUMMARY

The various embodiments of the present disclosure relate in general to devices, systems, and processes for providing producers of consumables and/or others with consumable data regarding a consumable throughout one or more stages of a consumable chain. In accordance with at least one embodiment of the present disclosure, a system includes a data processing system configured to enable a first entity to control dispensing of a consumable provided in a package. The system may also include an Internet-of-Things (IoT) device directly associated with the package and a communications system communicatively coupling the IoT device with the data processing system.

For at least one embodiment, the first entity may be a producer of the consumable. The consumable may include a beverage, such as beer. The package may include an enclosure for beer, such as a beer keg.

For at least one embodiment, the IoT device may include and/or be coupled to a valve. The IoT device may be adapted to control the package by selecting an operating state for the valve. Operating states for a valve may include a first operating state for the valve as an open valve state and a second operating state for the valve as a closed valve state.

For at least one embodiment, the data processing system may be configured to provide a user interface by which the first entity can remotely control the opening and closing of the valve. The valve may be separate from and/or integrated with at least one of the IoT device and the keg.

For at least one embodiment, the IoT device may be configured to capture consumable data regarding the consumable and communicate the consumable data to the data processing system. The consumable data may include at least one of environmental data, location data, consumption data, and transactional data.

For at least one embodiment, the consumable data may indicate a current temperature of the package. The IoT device may be configured to select the operating state of the valve based on the current temperature of the consumable. The IoT device may be directly associated with the consumable by directly measuring the current temperature of the consumable.

For at least one embodiment, transactional data includes payment information provided by a consumer of the consumable. The IoT device may be configured to control the operating state of the valve based upon the payment information provided by the consumer. The transactional data may include an age status indicator for the consumer and the IoT device may be configured to close the valve when the consumer is not of proper age to receive the consumable.

For at least one embodiment of the present disclosure, a device for controlling dispensing of a consumable may include a valve connected to a package containing a consumable and a processor configured to control an operating state of the valve. The valve, when in an open state, allows dispensing of the consumable from the package and, when in a closed state, the valve prohibits dispensing of the consumable from the package. The device may include a communications device configured to communicatively couple the device with a data processing system. The data processing system may be configured to enable a first entity to remotely control the operating state of the valve.

For at least one embodiment, the consumable is an alcoholic beverage, such as beer. The package is a beer keg and the valve is attached to outlet of the beer keg.

For at least one embodiment, the device is an Internet-of-Things (IOT) device. The device may be configured to receive consumable data and communicate the consumable data to the data processing system. The consumable data may include at least one of environmental data, location data, consumption data, and transactional data.

In accordance with at least one embodiment of the present disclosure, a process for monitoring and controlling dispensing of beer from a beer keg may include the operations of directly associating an Internet-of-Things (IOT) device with a package for a consumable. For at least one embodiment, the consumable may include an alcoholic beverage, such as beer and the package may be a beer keg.

For at least one embodiment, the process may also include one or more operations including monitoring a location of the IoT device; monitoring an operating condition of the IoT device; and monitoring a security condition of the IoT device.

For at least one embodiment and when a security condition indicates the IoT device is not secure, the operations may also include configuring a valve connected to an outlet of the beer keg into a closed state.

For at least one embodiment, the process may also include one or more operations including monitoring the IoT device for an alarm condition; and monitoring at least one condition for at least one of the consumable and the package. For at least one embodiment, the at least one condition may include at least one environmental condition.

For at least one embodiment, the process may also include one or more operations including determining whether a task has been requested and completed. For at least one embodiment, the task may include at least one of: approving dispensing of the consumable to a consumer; processing transactional data for a dispensing of the consumable; opening the valve to allow dispensing of the consumable; and closing the valve to cease dispensing of the consumable.

### BRIEF DESCRIPTION OF THE DRAWINGS

The features, aspects, advantages, functions, modules, and components of the devices, systems and processes provided by the various embodiments of the present disclosure are further disclosed herein regarding at least one of the following descriptions and accompanying drawing figures. In the appended figures, similar components or elements of the same type may have the same reference number and may include an additional alphabetic designator, such as 108a - 108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When only the first reference label is used in the specification, the description is applicable to any of the similar components and/or views having the same first reference number irrespective of any additional alphabetic designators or second reference labels, if any.

FIG. 1 is a schematic representation of a system for use with an IoT device configured to provide consumable data regarding a consumable and in accordance with at least one embodiment of the present disclosure.

FIG. 2 is a schematic representation of an IoT device in accordance with at least one embodiment of the present disclosure.

FIG. 3 is a flow chart depicting an algorithm for use by a data processing system in in monitoring, controlling and/or interacting with an IoT device and in accordance with at least one embodiment of the present disclosure.

### DETAILED DESCRIPTION

The various embodiments described herein are directed to devices, systems, and processes for providing producers consumable and others with consumable data regarding a consumable throughout one or more stages of a consumable chain. One or more of the various embodiments described herein utilize combinations of Internet of Things (IoT) devices or similar devices, mobile computing technologies, such as those provided by smartphones, tablets and the like, network based data sources, such as those provided by Cloud and/or mobile based computing resources, and other technologies to provide producers and others with consumable data regarding a consumable throughout one or more stages of a consumable chain.

As used herein, a “consumable” is an item of commerce that is fit for human and/or animal consumption. Examples of consumables include, but are not limited to, adult beverages, such as beers, craft beers, wine, whiskeys, and the like, foodstuffs, such as meats, poultry, fish, baked goods, dairy products, and the like, and other items of commerce. One or more of the various embodiments of the present disclosure may also apply to and/or be used in conjunction with other (non-consumable) items of commerce, such as petrol, fertilizers and other products that may spoil or degrade over time and/or if not maintained under desired conditions. It is to be appreciated that a consumable chain, for a given consumable, may arise and with respect to any desired stage of monitoring, tracking, inventorying or otherwise.

As used herein and for purposes of conciseness only, the producing, shipping, storing, dispensing, consumption, and other actions regarding a consumable is individually, collectively and generally referred to herein as “providing” the consumable.

As used herein, a “producer” is an entity that produces a consumable for ultimate end consumption by one or more persons or animals. A producer often produces such consumables under their brand and/or under a private label brand. A producer may provide a consumable that is intended for combination with other items to provide an end product. For example, a producer of a soft-drink (such as COCA-COLA™) may provide the syrup which is combined in a soda dispenser with carbonated water to provide a selected soft-drink to a consumer for consumption thereby.

As used herein, a “distributor” is an entity that receives a consumable from a producer and provides such consumable, with or without modification, to a retailer.

As used herein, a “retailer” is an entity that receives a consumable from a producer directly or indirectly, for example, via a distributor, and provides the consumable for sale, presentation, dispensing, or otherwise to an ultimate end user consumer, such as a person or animal.

As used herein, a “consumer” is an end user (human or animal) that ultimately consumes (if it is consumed at all) the consumable.

It is also to be appreciated, that any given entity may fulfill one or more roles of a producer, distributor, retailer and/or consumer along a consumable chain. For example, a restaurant providing food delivery services, may be both a producer and a retailer of a consumable. When the food delivery service is provided by a third-party, such as DOOR-DASH™, the producer and retailer may be the restaurant, but, the distributor may be the third-party delivery service. Likewise, when an employee of the restaurant eats the food, the restaurant may also become the consumer.

It is to be appreciated, that a given type, quantity or characteristics of consumable data regarding a consumable provided by one or more embodiments of the present disclosure may be relevant, desired, by, informative to, or otherwise intended for use by one or more of a producer, distributor, retailer or consumer at various times throughout the consumable chain. The types and characteristics of such consumable data used by any entity, vis-à-vis any other entity, may blend, overlap, be modified or otherwise provided and/or used, as desired for any given embodiment. For example, each of a producer, distributor, retailer and/or consumer may desire to know the “use by” date for a consumable, such as a gallon of milk. Similarly, a retailer (such as a restaurant) or diner (a consumer) desiring to respectively use and eat only “fresh” and “locally sourced” consumables may desire to know the provenance of the consumable from farm to kitchen.

Likewise, it is to be appreciated, that a given consumable often is produced and intended for consumption with an understanding that a desired quality of such consumable is provided when the consumable is shipped, stored, offered to consumers, otherwise provided, and ultimately consumed under certain environmental and/or other conditions. For example, a beer may be considered having the desired quality when provided by a certain date and within a given temperature range (for example, the beer is neither too cold, too hot, exposed to atmospheric pressures for more than an acceptable time period), or otherwise.

Accordingly, the various embodiments of the present disclosure are directed to capturing and providing consumable data regarding a consumable. Herein, a non-limiting beer keg embodiment is described wherein an IoT sensor is utilized to capture consumable data regarding a given keg of beer. It is to be appreciated, however, that the various embodiments of the present invention are not so limited and any form of IoT sensors, or the like, may be used to provide consumable data regarding a consumable along one or more stages of a consumable chain.

As used herein, “real-time” generally relates to periods that arises within a given window throughout one or more stages of a consumable chain. Real-time may include a period that occurs prior to a consumable entering into a consumable chain, such as conditions arising during production of a given consumable. Real-time may include consumable data arising during a consumable chain. As used herein, a consumable chain is considered to be initiated when a “monitoring entity” (which may be one or more of a producer, distributor, retailer or consumer) initiates the capture of consumable data (hereafter, “monitoring”) regarding a consumable. The time at which monitoring is initiated is referred to herein as the “monitoring start time (MST).” It is to be appreciated that a monitoring start time for any given consumable may be unique or non-unique. A monitoring start time may begin automatically, semi-automatically, by a human action, or otherwise. For example, monitoring may begin when a consumable has reached a traceable status, such as one that is ready for packaging or dispensing. Likewise, monitoring may begin when a human (or machine) scans a barcode, a radio frequency identification (RFID) code is read, Bluetooth Low Energy (BLE) device is activated, or other unique identifier of a given consumable is operable. Accordingly, it is to be appreciated that monitoring of a consumable may occur at any desired stage of a consumable chain. For at least one embodiment, monitoring of a consumable may include an operation of associating a given consumable with a device configured to provide consumable data regarding that given consumable.

Further, monitoring of a consumable is considered to be complete when the consumable has proceeded to/through a desired completion stage of a consumable chain. Such completion stage being designated herein as marking a “monitoring end time (MET).”

For at least one embodiment, monitoring of a consumable may be bounded by an MST and a MET. It is to be appreciated that different entities may have different monitoring start and end times with respect to a given class, group or individual consumable. For example, a producer may initiate monitoring upon production of the consumable, while a retailer may initiate monitoring upon receipt of the consumable. Similarly, a producer may initiate monitoring of a rare or vintage consumable at a different time and/or under different conditions and/or with different monitoring being used than is monitoring of a common consumable.

It is also to be appreciated, that the consumable data provided during monitoring of a consumable may be of a transient and/or non-transient nature. Some consumable data, such as a temperature, may be transient unless one or more threshold settings is exceeded, in which instance that same temperature data may become non-transient by storage in a suitable data storage device. Likewise, some consumable data may expire, unless other actions are taken, for example, prior to a MET for a given monitoring.

In accordance with at least one embodiment of the present disclosure, consumable data may be captured, recorded (as desired), and communicated to a monitoring entity using any know or later arising technologies. Such consumable data may be processed automatically, semi-automatically and/or manually into consumable information, if desired. Consumable data may be uniquely associated with a given consumable using Blockchain and similar technologies. As used herein, “consumable information” refers to information, based on consumable data, that is presented to a monitoring entity. Consumable information may include consumable data, may be derived from consumable data and/or may be presented to a monitoring entity at any time in any form or format, such as raw consumable data, processed consumable data, or otherwise. Accordingly, as used herein, “consumable data” refers to outputs of a monitoring device and “consumable information” refers to the presentation of such consumable data, which may be processed, to a monitoring entity. Herein and for purposes of clarity and conciseness, “consumable information” and “consumable data” are collectively referred to as “consumable data” and such terms may be used interchangeably. A person having ordinary skill in the art should recognize and distinguish between the capture of data and the presentation of such data, in raw or processed form, to a human, a computerized process, or otherwise with the presenting including the providing of data and/or information. For at least one embodiment, consumable data may be provided but does not need to be provided “real-time” to a monitoring entity. For at least one embodiment, consumable data may be provided at any time after the consumable data is captured, processed, or otherwise ready for presentation to a monitoring entity.

As used herein, a “monitoring entity” is any entity, human, process, or otherwise that receives consumable data for the purpose of monitoring a consumable during at least one s5tage of a consumable chain.

It is to be appreciated that any desired form of consumable data may be captured, processed (as desired) and provided to a monitoring entity. Non-limiting examples of such consumable data include environmental data, such as temperature, rate of temperature change, wind conditions, humidity conditions, and other forms of environmental data. Any form of environmental data capture, communication, preservation, and presentation technologies may be utilized with one or more embodiments of the present disclosure to provide environmental data regarding a consumable to a monitoring entity.

For at least one embodiment, consumable data may be categorized into one or more sub-categories, such as location data, consumption data, transactional data (such as, how and by what means is a consumable purchased for end consumption by a consumer), and other sub-categories of data. For a non-limiting example, “location data” may include data identifying where a given consumable is at a given time. A “bread-crumbs” route may be generated and presented as location information. Such route may be based upon one or more discrete location data points that identify how and/or when a given consumable proceeds from a producer (or other entity) to a consumer (by one or more other intermediaries).

For at least one embodiment, consumable data may include “consumption data.” For example, a beer keg may be monitored for the frequency (how often the beer is poured) and the volume of any given pour (such as, a pint, yard, pitcher, or otherwise).

For at least one embodiment, consumable data may include “transactional data.” Such transactional data may identify, for example, how consumers commonly pay for a given consumable. For example, are consumers of a given beer more apt to pay for the beer using cash, debit or credit cards Likewise, transactional data may provide or lead to the providing of information regarding how often free “pours” are provided. Other transactional data may be captured and processed into transactional information, as desired for any given embodiment of the present disclosure.

With the advent of interconnected devices, such as IoT devices and other peripheral devices (hereafter individually and collectively, “IoT devices”), global positioning system (GPS) and other location determination systems, cloud based storage technologies, digital record keeping systems and other technologies, it is to be appreciated that an insignificant amount of consumable data can be generated for a given consumable. Such consumable data may refer to a single instance of consumable data, such as a single temperature reading, or a collection of consumable data, such as a temperature trend line, an average, or otherwise. Consumable data may be captured and, as desired, provided to a monitoring entity for any desired purpose.

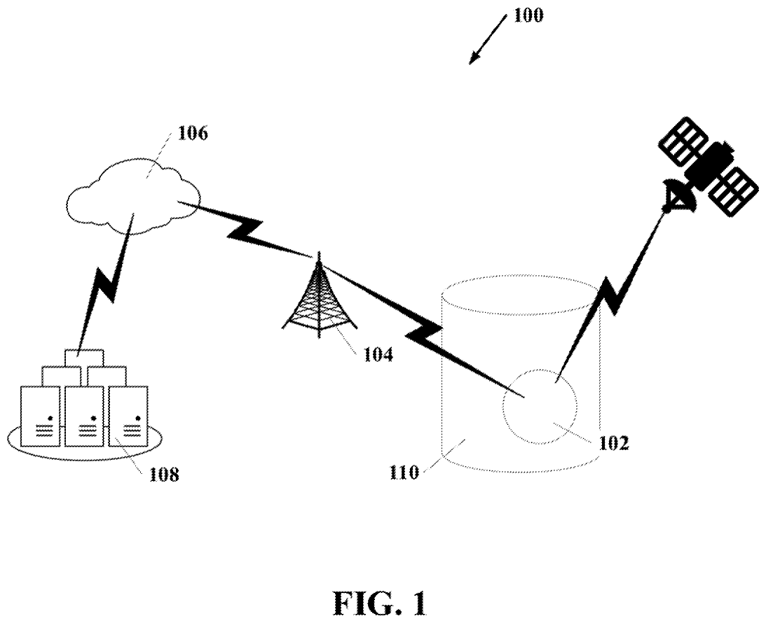

As shown in FIG. 1 and for at least one embodiment of the present disclosure, a system 100 for providing at least one monitoring entity with consumable data regarding a consumable includes at least one IoT device 102 communicatively coupled to a local communications system 104, which is communicatively coupled, via a network 106 or otherwise, to a data processing system 108. The IoT device 102 may be directly associated and/or indirectly associated with a given consumable 110. For at least one embodiment, location data regarding the consumable 110 may be provided by use of location system 112 such as a global positioning system (GPS) and/or other location positioning system and communicatively provided to the IoT device 102 and/or to the data processing system 108.

As used herein “directly associated” refers to a physical coupling of the IoT device 102 with the consumable 110. For example, an individually packaged item that is typically consumed in its entirety at a given time (excluding “left-overs”) such as a cut of steak, may be directly associated with an IoT device 102 by physical attachment of the IoT device 102 to the consumable. The IoT device may be discarded by the consumer prior to ingestion of the steak. It is to be appreciated that an IoT device 102 directly associated with a given consumable may be intended for removal from the consumable at any time prior to consumption of the consumable.

For example, an IoT device 102 attached to a cut of steak may be directly associated with the steak through one or more stages of food distribution, production and preparation, including, up to food serving, with the IoT device 102 being removed from the cut of steak immediately prior to the time of ingestion. It is to be appreciated, that by providing such a direct association, consumable data regarding how the cut of steak is actually prepared and served (e.g., is it raw, medium, or well-done—as based, for example, upon a measured temperature) can be collected and provided to a monitoring entity.

It is likewise to be appreciated that a given consumable may not be provided or capable of being monitored on a single-use or single serving basis. For example, beer is often provided in bulk, such as in a case, keg or otherwise Likewise, bread is often provided as a loaf in a bread wrapper. The keg and bread wrapper are non-limiting examples of a consumable's “packaging.” It may be impractical and/or undesirable (for any or no reason) to directly associate an IoT device 102 with a given consumable. Accordingly, as used herein an IoT device 102 may be “indirectly associated” with a given consumable by being directly associated with the packaging used for such given consumable. For example, a given pint of beer drawn from a keg, may be indirectly associated with a given IoT device 102 based on a direct association of the IoT device 102 with the keg itself. Similarly, an IoT device 102 may be directly associated with packaging for a given loaf of bread and indirectly associated with each individual slice of bread provided in the packaging for such loaf of bread.

For at least one embodiment, an IoT device 102 may be both directly associated and indirectly associated with a given consumable. For example, an IoT device 102 may be configured to both monitor a dispensing of a consumable and the packaging of the consumable throughout one or more stages of a consumable chain. For example, an IoT device 102 may be configured at a “valve”, “coupler” or “tap”, “tower”, “faucet” or other component of a keg of a beer dispensing system to both monitor and report consumable data regarding an individual “draw” of beer from the keg, as well as monitoring one or more conditions to which the keg itself is exposed during one or more stages of a consumable chain.

As shown in FIG. 1, the IoT device 102 may be communicatively coupled to a data processing system 108 using one or more communications systems 104 and or networks 106. Any form of communications system 104, technologies, and components may be used. For at least one embodiment, the IoT device 102 is communicatively coupled to a local area network (not shown) using Bluetooth Low Energy technology. The local area network may be connected, via the Internet, to the data processing system 108. For at least one embodiment, the IoT device 102 may be communicatively coupled to the data processing system using a wireless communications technology, such as a 3G/4G/5G cellular connection, via WIFI™, and otherwise. For at least one embodiment, the IoT device 102 may be communicatively coupled to the data processing system 108 using a wireless mesh communications network. For at least one embodiment, the IoT device 102 may be communicatively coupled to the data processing system 108 using at least one of a wired system, wireless system, or a combination thereof. For at least one embodiment, the IoT device 102 may be directly communicatively coupled to the data processing system.

The network 106, when used, may be any desired communications network and/or combinations thereof, such as the Internet, a local area network, a wide area network, a dedicated network, an undedicated network, private network, a public network, or otherwise. For at least one embodiment, communications between the IoT device 102 and the data processing system 106 may be unidirectional (such as where the IoT device 102 is configured to solely receive or transmit consumable data), bi-directional, or otherwise. Any presently available and/or later arising communications systems, networks, technologies, or otherwise may be utilized with one or more embodiments of the present disclosure.

The data processing system 108 may be any general purpose computing device consisting of hardware and non-transient computer executable instructions configured to provide one or more of the features and/or functions described herein. For at least one embodiment, the data processing system 108 may include one or more hardware processors, such as 32-bit and 64-bit central processing units, multi-core ARM based processors, microprocessors, microcontrollers, and otherwise (hereafter, “computer processor(s)”). The non-transient computer executable instructions may include instructions for executing one or more applications, engines, and/or processes configured to perform computer executable operations (hereafter, “computer instructions”). Such hardware and software technologies may arise in any desired computing configuration including, but not limited to, those local, remote, distributed, blade, virtual, or other configurations and/or systems configured for use in support of the one or more embodiments of the present disclosure.

The data processing system 108 may include one or more transient and/or non-transient data storage components (not shown). Such data storage components may include hardware and non-transient computer instructions configured to facilitate storage of consumable data. Such data storage, for any given element of consumable data, may occur for any desired time period, including indefinitely. Any known or later arising data storage hardware and computer instructions may be used with one or more embodiments of the present disclosure.

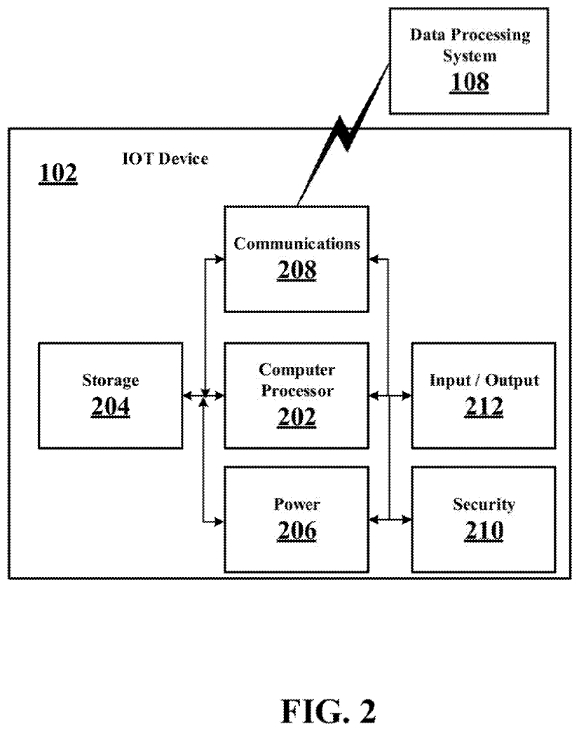

As shown in FIG. 2 and for at least one embodiment of the present disclosure, an IoT device 102 may include a computer processor 202, a storage device 204, a power device 206, a communications device 208, a security device 210, and an input/output device 212. The input/output device 212 may be communicatively coupled to one or more external input/output (I/O) devices (not shown). The communications device 208 may be communicatively coupled to the data processing system 108. as discussed above with reference to FIG. 1.

For at least one embodiment, the computer processor 202 may include one or more hardware components configured for data processing operations. Such data processing operations may include executing of computer instructions. The computer instructions may be provided in the storage device 204, provided with the computer processor 202 itself, such as in cache or read only memory, as firmware, or otherwise. The computer processor 202 may include any configuration of currently available and/or later arising hardware processing elements, including microprocessors, microcontrollers, CPUs and otherwise. The computer processor 202 may be communicatively coupled to each of the elements shown in FIG. 2. Such communicative coupling may occur by use of a system bus, direct connections, indirect connections, or otherwise. The computer processor 202 executes computer instructions to facilitate the various features and functions of the IoT device 102, as so configured in accordance with one or more embodiments of the present disclosure.

The IoT device 102 may include a storage module 204. The storage device 204 may be configured to stored consumable data, computer instructions and other data on a transient and/or non-transient basis. Whether a given element of consumable data and/or computer instructions are stored on a transient or non-transient basis may be determined based upon an intended usage of the data, data storage availability, other data storage requirements, whether such data has been previously communicated to the data processing system 108, whether such consumable data is current or old (as determined in view of an intended use of such data), and otherwise. It is to be appreciated that any desired data storage technologies, processes, and the like currently available or later arising may be used for one or more embodiments of the present disclosure. For at least one embodiment, the IoT device 102 utilizes flash memory storage technologies providing at least two Gigabytes (2 GB) of data storage capability. Other, if any, data storage capacities may be used for other embodiments.

The IoT device 102 may include a wired, wireless or combination thereof power device 206. When wireless, the power device 206 may include one or more batteries configured to provide electrical power to the IoT device 102 on a permanent, transient, intermittent, or other basis. For at least one embodiment, the power device 206 may include one or more rechargeable batteries. Such recharging may occur using line power, such as that provided by a home or business, solar, wind, or otherwise. For at least one embodiment, an IoT device 102 may be powered by line power.

The IoT device 102 may include a communications device 208. The Communications device 208 may include any desired combination of receive, transmit, encryption, compression, and other communications technologies. Any known or later arising communications technologies may be utilized by and/or in conjunction with the communications device 208. The communications device 208 may be configured to provide consumable data to the data processing system 108. The providing of such data may occur on any desired timeline, frequency, basis or otherwise. For example, consumable data may be continual, on an alert, periodically, randomly, on an as queried (or “pulled”) basis, or otherwise communicated to the data processing system 108. One or more elements of available consumable data may be communicated at any given time. For example and for at least one embodiment, temperature data may be communicated periodically, while transactional data is communicated on a per transaction basis.

The IoT device 102 may include an input/output device 212. The input/output device 212 may take any desired form and may be configured to receive any desired inputs and provide any desired outputs. For example, inputs may be received from sensors external to an IoT device, such as a room temperature sensor, from an operator, such as a “start” input, from another IoT device, such as a reading from a co-located IoT device sensor, from a process or external system, such as transactional information provided by a payment terminal, or otherwise. Inputs may be provided in any desired manner, such as wirelessly, by wired connection, by human input (including touch inputs, voice commands and otherwise), or otherwise. For at least one embodiments, outputs may be provided by the input/output device 212 in any desired form or manner. For example, outputs may be provided as humanly perceptible tones, images, graphics, indicators (visible, audible, tactile) or otherwise. Likewise, outputs may be provided to other IoT devices, to other systems or otherwise.

The IoT device 102 may include a security device 210. The security device may be configured to provide any desired type or level of virtual and/or physical security. As used herein “virtual security” refers to the securing of data, data processes, data communications and the like. Non-limiting examples of virtual security include the use of encryption, passwords, biometric authenticators and the like. As used herein, “physical security” refers to the securing of an IoT device 102 and, as desired, any related components, relative to one or more consumables. Non-limiting examples of “physical security” measures that may be used include tumbler locks, magnetic locks, compression collars, and other technologies that may be used to secure an IoT device to a given consumable (either by direct association and/or indirect association of the IoT device with the consumable). One or more of the various embodiments of the present disclosure may utilize any desired form of known and/or later arising virtual security, physical security and combinations thereof security measures.

For at least one non-limiting example of a use case, an IoT device 102 may be configured as a monitoring device for a given consumable. For example, an IoT device 102 directly associated with a keg of beer may be configured to control one or more conditions under which beer may be drawn from a given keg. The IoT device 102 may be provided integral with a given keg. The IoT device 102 may be physically secured to the keg. For at least one embodiment, one or more locking mechanisms may be used to secure an IoT device 102 to a given keg. For at least one embodiment, removal of the IoT device 102 may trigger an alarm. The alarm may generate a sound, light or other signal that is perceptible to a human proximate to the keg. For at least one embodiment, the alarm may generate an alarm message. The alarm message may be communicated to the data processing system at any given time and/or under any desired alarm conditions.

It is to be appreciated that consumable data and information received and made available by the data processing system may be accessed by any desired entity, under any desired conditions. For example, an alarm message indicating that beer is being dispensed under other than desired environmental or conditions may be communicated to a producer (such as a brewer). Similarly, an alarm message indicating that a draw is wasteful, for example, by the dispensing too much beverage for a given quantity purchased, or that the draw has occurred “after-hours” may be communicated to a retailer, such as a restaurant manager, or others, such as a governmental regulating body or entity. Accordingly, it is to be appreciated that consumable data provided by an IoT device 102 to a data processing center regarding a consumable may be used for any desired lawful purpose and provided to any desired entity or entities.

For at least one embodiment, an IoT device 102 may provide a control mechanism. An IoT device 102 may include one or more electro-mechanical valves that can be used to control when and how beer is dispensed from a keg. The IoT device 102 may be configured such that the dispensing of beer “after-hours” is prohibited. The IoT device 102 may be configured to prohibit dispensing of beer when desired environmental conditions are not being satisfied, for example, the beer is not within proscribed temperature, pressure, or otherwise. The IoT device 102 may be configured to control beer dispensing automatically. The IoT device 102 may be configured to be controlled by a remote entity, such as a producer or distributor. The remote entity may desire, for example, to prohibit dispensing of beer from a given keg when specified conditions set between the remote entity and, for example, the retailer have not been satisfied. Examples of such specified conditions may include payment terms, storage terms, dispensing volume terms, environmental conditions, or otherwise.

For at least one embodiment, an IoT device 102 includes one or more sensor configured to monitor one or more environmental or other conditions. An IoT device 102 associated, for example, with a keg of beer may include temperature sensors (internal and/or external to the keg), motion sensors (indicative of unsettling of the beer), pressure sensors, or otherwise. An IoT device 102 may be configured to receive environmental and/or other consumable data from other sensors or systems, including those not directly connected to a given IoT device 102, such as the temperature reported by a storage room temperature sensor.

For at least one embodiment, an IoT device 102 may be configured to communicate with a user identification system. The user identification system may be configured to provide or require the use of authorization codes. Such authorization codes may be used to control an IoT device for one or more of financial, legal or other purposes. The control of the IoT device 102 enables remote control of the keg and the dispensing (or non-dispensing—as the case may be) of beer from the keg under desired terms and conditions. For example, an IoT device 102 may be directly associated with a keg provided at a college party where underaged drinkers may be present. The IoT device 102 may be configured to allow dispensing of beer only upon a requesting consumer providing verification to the IoT device 102 that such person is of legal drinking age. Such verification may be provided, for example, by use of a wrist band embedded with a near field communications (NFC) chip in close proximity to the IoT device 102. The wrist band may be issued by a trustworthy source. The wrist band may be communicatively linked, for example, using NFC, to an approved beverage container, such as an NFC encoded beer glass. The IoT device 102 may be configured to associate the beer glass with the person seeking dispensing of the beer and to facilitate monitoring and control of an amount of alcohol dispensed to such person, the rate of alcohol consumption, and otherwise. It is to be appreciated, that such an approach may be used by a college fraternity, dormitory, public event, or otherwise to monitor and ensure compliance with rules or regulations governing the dispensing of beer at a college event or otherwise.

For at least one embodiment, an IoT device 102 may be configured to accept payment and/or transactional information. The IoT device 102 may, itself, include one or more payment processing components and/or may be communicatively coupled to a payment processing component, such as one provided in a retail establishment. The IoT device 102 may be configured to allow the keg to dispense beer when payment has been provided and to prohibit dispensing of beer otherwise.

As discussed above, the data processing system 108 receives consumable data from an IoT device 102 and may be configured to interact and/or control the IoT device and the dispensing of a directly or indirectly associated consumable. The data processing system 108 may also be configured to execute one or more computer instructions that provide various features and functions including, but not limited to, inventory tracking and control, quality tracking and control, down chain vendor/consumer approvals/disapprovals, such as approving or disapproving of a retailer from dispensing, or further dispensing, a producer's beer, and otherwise. Further, the information collected by a data processing system 108 may be accessible by any desired participant in a consumable chain. For example, a producer, distributor, or retailer may access consumable data for one or more reasons, such as sales volume, inventory age, next shipment scheduling, promotions, marketing opportunities, co-branding opportunities or otherwise. Similarly, a consumer may access the consumable data for purposes including, but not limited to, status of their participation in a beer of the world or similar program, level of beer consumed per day, month, week, year, promotion redemption opportunities or otherwise. Accordingly, it is to be appreciated that the data processing system 108 may include any desired form of user interface features and functions, such as those provided by common web page interfaces which facilitate the providing of consumable data on an individual IoT device basis and/or as based on a collection of two or more IoT devices to any entity allowed to have access to such consumable data. Known and/or later arising data protection technologies may be utilized to secure consumable data and provide any desired level of access to the same by one or more persons, computer systems, entities or otherwise.

For example, a data processing system 108 may be configured to inform a retailer providing a keg of beer to a consumer to track the location of a given keg, via a directly associated IoT device 102. Based upon beer dispensed from such keg (assuming less than the entirety available in a given keg), as monitored by the IoT device 102, the retailer may desire to provide credits or refunds to a purchaser/consumer of such keg of beer, upon a return of the same to the retailer. Likewise, the IoT device's monitoring of the environmental conditions under which the keg of beer was stored while under physical possession by the consumer may also be used to facilitate approval of a transfer of a remainder of such keg of beer to a second consumer. The second consumer may be related or unrelated to the first consumer. That is quality assurances may be provided by an IoT device directly associated with a given keg, such that wasting unconsumed beer provided therein may minimized and/or avoided, as desired.

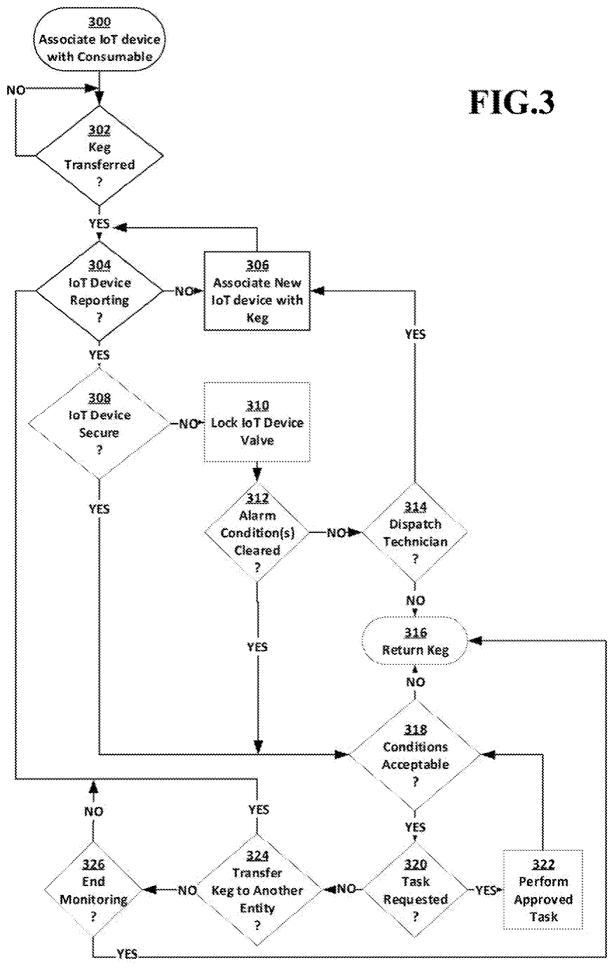

As shown in FIG. 3, one embodiment of a process for providing information for consumables begins with the association of an IoT device 102 with a consumable. (Operation 300) As discussed above, such association may occur directly or indirectly. For purposes of conciseness herein only, the above described non-limiting example of a beer keg is used. Further, for purposes of this discussion, the providing of the keg of beer from a producer, such as a brewer, to a distributor, then to a retailer, and ultimately to a consumer is described. It is to be appreciated, however, that the association of an IoT device with a consumable and processing of consumable data provided by such an IoT device may begin and end at any point along a consumable chain, as desired for any implementation of a given embodiment of the present disclosure. It is to be appreciated that for other embodiments, monitoring may occur earlier in the consumable production process, such as during the brewing of the beer, the handling of the keg (cleansing, etc.), the filling of the keg, the storage of the keg by the producer, and otherwise. As shown, the process awaits transfer of the keg to the distributor.

Per Operation 302, a determination is made as to whether the keg (the keg) with the consumable therein (the beer in the keg), has been transferred to another entity. For example, the keg may be transferred by and between any of a producer, a distributor, a retailer, and a consumer.

Per Operation 304, a determination may be periodically or otherwise made as to whether the IoT device is operable as determined by the IoT device continuing to report consumable data to the data processing system. If “No”, per Operation 306, a new IoT device may be associated with the keg. While shown only as arising in Operations 304 and 306, it is to be appreciated that one or more of such operations may occur repeatedly during monitoring of a consumable. For example, an IoT device may be configured to periodically send status updates to the data processing system. Such status updates may include consumable data, as desired, or may merely include an identification of the IoT device and that it remains operable.

Per Operation 308, a determination may be periodically or otherwise made as to whether the IoT device is secure. Secure, as used herein, may include virtual and/or physical security. As discussed above, an IoT device may be configured to be securely associated with a package and/or a consumable. Such security may include active monitoring and the active reporting of non-secure conditions. For example, an IoT device may include a capacitive sensor, a pressure sensor, or otherwise configured to indicate whether the IoT device is and has remained securely attached to an outlet of a keg, or to another desired element of such keg. When security of the IoT device with the keg is compromised, the IoT device may be configured to communicate an alarm message to the data processing system. A response to the alarm message may vary, as desired for any given implementation of an embodiment of the present disclosure.

Per Operation 310, one possible response to an alarm message is to physically lock a valve controllable by the IoT device attached to the keg. By physically locking the valve, the dispensing of beer, via the outlet manifold of the keg, may be prohibited.

Per Operation 312, a locking of an IoT device valve may continue until the condition(s) giving rise to the alarm message are cleared. It is to be appreciated that the clearing of an alarm may occur by clearing of an alarm due to an anomaly in the IoT device or by dispatching of a technician to clear the alarm, as per Operation 314. The alarm may also be overridden, as desired, ignored or result in a recall of the keg to the producer, as desired for any given implementation of an embodiment of the present disclosure. If a technician is not to be dispatched, the keg may be returned to the producer, as per Operation 316.

Per Operation 318, monitoring of a consumable by an IoT device may include a reporting (a “push” by the IoT device) and/or a querying (a “pull” by a data processing system to the IoT device) of the conditions under which the consumable is being stored, transported or otherwise maintained. Such reporting and/or querying may occur at any desired time, on any desired interval, upon a preset threshold being exceeded, or otherwise. Such monitoring of one or more conditions by the IoT device may occur continually, with the communicating of such one or more conditions occur as desired for that particular implementation. If the conditions as monitored, are not acceptable, one or more response options may include dispatching a technician, as per Operation 314, having the keg returned as per Operation 316, or otherwise (not shown). Such response options may include assessing fines, penalties, demerits, credits, refunds, or otherwise to the entity that is then in possession of the keg by one or more of the entities within the consumable chain. For example, a keg in possession of a consumer that is defective may result in an alarm that triggers the providing of a credit to the consumer's account. Such credit may be provided by the retailer, distributor, or producer, as desired for any given embodiment.

Per Operation 320, one or more tasks may be requested. For example, the IoT device may be requested to open a control valve so that the beer may be drawn from the keg. If a task is requested, an approval process may be used. Per Operation 322, approved tasks (for those embodiments where approval of a task is needed) may be performed. It is to be appreciated that for at least one embodiment, an IoT device may be configured as a monitor only device not as a control device. Accordingly, for such embodiments, operations 320 and 322 may not need to be performed. Further, it is to be appreciated that while one or more tasks are being performed, the operations may include the further monitoring of conditions. For example, the drawing of beer from a keg may include the further monitoring of the pressure and/or temperature of the beer being withdrawn. The IoT device may be configured to respond accordingly when undesired conditions are detected. Such response may include, but is not limited to, further cooling the beer, increasing the amount of pressure provided to the beer, or otherwise.

Per Operation 324, the keg may be transferred to another entity, such as by the retailer to a consumer. For at least one embodiment, the monitoring of consumable data and reporting/communicating of the same to the data processing system may occur throughout one or more, including all, stages of the consumable chain.

Per Operation 326, a determination may be made to end monitoring. If so, then the keg is desirably returned to the proper entity. It is to be appreciated that for at least one embodiment, the end of monitoring may occur co-incident with the return of the keg to the proper entity. The proper entity may be a retailer, or other entity, that provided the keg, a recycling center, or otherwise. For embodiments wherein the IoT device is directly associated with a consumable, versus being directly associated with packaging for a consumable, operation 316 may include the return of the IoT device itself.

As shown by FIG. 3, the various embodiments of the present disclosure may be configured to monitor a consumable throughout one or more stages of a consumable chain. Such monitoring may occur by any entity having permission and access to a given IoT device and for any period, including indefinitely. Accordingly, it is to be appreciated that the operations depicted in FIG. 3 are illustrative only and are not intended herein to occur, for all embodiments of the present disclosure, in the order shown, in serial, or otherwise. One or more operations may be performed in parallel and operations may be not performed, as provided for any given use of an IoT device configured to provide consumable data.

Although various embodiments of the claimed invention have been described above with a certain degree of particularity, or with reference to one or more individual embodiments, those skilled in the art could make numerous alterations to the disclosed embodiments without departing from the spirit or scope of the claimed invention. The use of the terms “approximately” or “substantially” means that a value of an element has a parameter that is expected to be close to a stated value or position. However, as is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more embodiments of the present disclosure. It is also to be appreciated that the terms “top” and “bottom”, “left” and “right”, “up” or “down”, “first”, “second”, “next”, “last”, “before”, “after”, and other similar terms are used for description and ease of reference purposes only and are not intended to be limiting to any orientation or configuration of any elements or sequences of operations for the various embodiments of the present disclosure. Further, the terms “coupled”, “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an embodiment of the present disclosure. Other embodiments are therefore contemplated. It is intended that all matter contained in the above description and shown in the accompanying drawings shall be interpreted as illustrative only of embodiments and not limiting. Changes in detail or structure may be made without departing from the basic elements of the invention as defined in the following claims.

1. A system, comprising:
a data processing system configured to enable a first entity to control dispensing of a consumable provided in a package;
an Internet-of-Things (IoT) device directly associated with the package; and
wherein the IoT device is directly communicatively coupled with the data processing system using a wireless communications technology.

2. The system of claim 1,
wherein the first entity is a producer of the consumable.

3. The system of claim 1,
wherein the consumable is beer; and
wherein the package is a beer keg.

4. The system of claim 3,
wherein the IoT device further comprises a valve;
wherein the IoT device is adapted to control the package by selecting an operating state for the valve;
wherein a first operating state for the valve is an open valve state; and
wherein a second operating state for the valve is a closed valve state.

5. The system of claim 4,
wherein the data processing system is further configured to provide a user interface by which the first entity can remotely control opening and closing of the valve.

6. The system of claim 5,
wherein the valve is integrated with at least one of the IoT device and the keg.

7. The system of claim 1;
wherein the IoT device is configured to capture consumable data regarding the consumable and communicate the consumable data to the data processing system.

8. The system of claim 7,
wherein the consumable data comprises updates to location data for the package and at least one of environmental data, consumption data, and transactional data and
wherein the location data for the package varies with time.

9. The system of claim 7,
wherein the consumable data indicates a current temperature of the package.

10. The system of claim 9,
wherein the IoT device is configured to select an operating state of a valve based on the current temperature of the consumable.

11. The system of claim 10,
wherein the IoT device is directly associated with the consumable by directly measuring the current temperature of the consumable.

12. The system of claim 8,
wherein the transactional data includes payment information provided by a consumer of the consumable.

13. The system of claim 12,
wherein the IoT device is configured to control an operating state of a valve based upon the payment information provided by the consumer.

14. The system of claim 12,
wherein the transactional data includes an age status indicator for the consumer; and
wherein the IoT device is configured to open a valve when the consumer provides an age verification to the IoT device.

15. A device for controlling dispensing of a consumable comprising:
a valve connected to a package containing a consumable;
an Internet-of-Things (IoT) device further comprising:
a processor configured to control an operating state of the valve;
wherein the valve, when in an open state, allows dispensing of the consumable from the package;
wherein the valve, when in a closed state, prohibits dispensing of the consumable from the package;
a communications device configured to directly communicatively couple the IoT device with a data processing system; and
wherein the data processing system is configured to enable a first entity to remotely control the operating state of the valve.

16. The device of claim 15,
wherein the consumable is beer;
wherein the package is a beer keg; and
wherein the valve is attached to outlet of the beer keg.

17. The device of claim 15,
wherein the device is an Internet-of-Things (IOT) device.

18. The device of claim 15,
wherein the device is further configured to receive consumable data and communicate the consumable data to the data processing system.

19. The device of claim 18,
wherein the consumable data comprises at least one of environmental data, location data, consumption data, and transactional data.

20. A process for monitoring and controlling dispensing of beer from a beer keg, comprising:
directly associating an Internet-of-Things (IOT) device with a package for a consumable;
wherein the consumable is beer and the package is a beer keg;
continually monitoring a location of the IoT device;
wherein the location of the IoT device varies over time;
monitoring an operating condition of the IoT device;
monitoring a security condition of the IoT device;
when the security condition indicates the IoT device is not secure, configuring a valve connected to an outlet of the beer keg into a closed state;
monitoring the IoT device for an alarm condition;
monitoring at least one condition for at least one of the consumable and the package;
wherein the at least one condition is at least one environmental condition; and
determining whether a task has been requested and completed;
wherein the task is at least one of:
approving dispensing of the consumable to a consumer;
processing transactional data for a dispensing of the consumable;
opening the valve to allow dispensing of the consumable; and
closing the valve to cease dispensing of the consumable.
